(19) United States
(12) Patent Application Publication
(10) Pub. No.: US 2026/0157366 A1
(43) Pub. Date: Jun. 11, 2026

(54) USE OF SPONTANEOUS ENCAPSULATION DELIVERY FOR THE PURPOSE OF PROVIDING THERAPEUTIC AID TO DESIRABLE AQUATIC ORGANISMS OR THE MITIGATION OF UNDESIRABLE AQUATIC ORGANISMS RESIDING WITHIN AN AQUEOUS ENVIRONMENT

(71) Applicant: Ocean Alchemists LLC, Tampa, FL (US)

(72) Inventors: Katie Sybil Curtis, Tampa, FL (US); Michael David Favero, Tampa, FL (US)

(21) Appl. No.: 19/411,243

(22) Filed: Dec. 6, 2025

Related U.S. Application Data
(60) Provisional application No. 63/729,295, filed on Dec. 6, 2024.
(60) Provisional application No. 63/893,916, filed on Oct. 5, 2025.

(51) Int. Cl. A01N 25/04; A01N 31/16; A01N 33/12; A01N 59/08; A01N 59/16; A01N 65/06; A01N 65/22; A01N 65/24; A01N 65/42; A01N 65/44; A01N 65/48; A01P 13/00

(52) U.S. Cl. CPC A01N 25/04; A01N 31/16; A01N 33/12; A01N 59/08; A01N 59/16; A01N 65/06; A01N 65/22; A01N 65/24; A01N 65/42; A01N 65/44; A01N 65/48; A01P 13/00

(57) ABSTRACT

The invention relates to a composition and a method of use to deliver the composition to a target aquatic organism in a body of water. The composition includes at least a first emulsifier, a coemulsifier, and one active ingredient that has a hydrophobic characteristic. In one embodiment, the target aquatic organism is a colony of coral with a plasma membrane or a mucosal layer that contacts the colony of coral and the body of water. In another embodiment, the target organisms are freely dispersed microorganisms such as Karenia brevis. When the composition contacts the body of water, the composition semi-spontaneously forms a collection of sphericals. The composition provides a method of delivering localized high concentrations of an active ingredient while keeping nonlocalized active ingredient concentrations low. The sphericals help deliver more of the active ingredients to the to the target aquatic organism than previous prior art “dipping” methods.

### RELATED APPLICATIONS

This application claims priority to U.S. Provisional Application Ser. No. 63/729,295, filed on Dec. 6, 2024, and entitled “Spontaneous encapsulation delivery for the purpose of providing therapeutic aid to aquatic organisms residing within an aqueous environment”, as well as U.S. Provisional Application Ser. No. 63/893,916, filed on Oct. 5, 2025, and entitled “Use of spontaneous encapsulation delivery for the purpose of providing therapeutic aid to desirable aquatic organisms or the mitigation of undesirable aquatic organisms residing within an aqueous environment”, both of which are incorporated herein by reference in their entirety.

### TECHNICAL FIELD

The present disclosure relates to a composition and a method of the composition's use that comprises at least three ingredients that is fashioned to deliver or administer a therapeutically effective amount of treatment, nutrition, and/or a toxic characteristic or a combination thereof to aquatic organisms or to toxins produced by aquatic organisms over a relatively short period of time while being subjected to a liquid environment.

### BACKGROUND

A composition that can deliver treatment or a toxic property that is protected by an emulsifier and a coemulsifier can make delivering treatment or the toxic property in an aquatic environment to an aquatic organism easier.

For instance, aquatic organisms, such as colonies of coral for instance, are often moved from one aquatic environment to another. When this occurs, there is great care and effort made in transferring the desirable aquatic organisms and stopping undesirable aquatic organisms from being transferred along inadvertently. Undesirable organisms are known to hitchhike on desirable organisms such as a coral colony from one environment to another. To prevent this from occurring, a common step during transfer is to subject the colony of coral to a “Dip” or a “Dipping”.

“Dipping” the colonies of coral typically includes the steps of removing the colony of coral from the original aquarium tank, transferring the colony of coral to a separate vessel filled with a body of water, and adding a composition that is designed to remove or eliminate any foreign bodies, infections, and other “hitchhiker” species from the colony of coral. Prior Art “dipping” compositions typically have a surfactant combined with a hydrophobic active ingredient to form small droplets which are stable for at least short periods of time. The composition is usually so laden with surfactants that the newly modified body of water itself could cause harm to the sensitive mucosal layer that typically covers the colony of coral if immersed in the separate vessel for an extended period of time. The composition delivers at least one active ingredient that provides some therapeutic benefit. A relatively large amount of the prior art composition is needed to accomplish this, since the composition tends to break down quickly if the separate vessel is not sufficiently modified by the addition of a large quantity of surfactants to the body of water in the separate vessel.

If the relatively high amount of surfactants or solubilizers are not present, then the prior art composition has a more difficult task of delivering the desired therapeutic effect to the colony of coral. As a result, delivering therapeutic treatment or nourishment to the colony of coral or any other aquatic organisms is difficult using the prior art “dipping” method.

In response, a new and novel way is disclosed to deliver treatment or nourishment to aquatic organisms such as colonies of coral that overcomes several of drawbacks of the prior art “dipping” method of delivering treatment or nourishment to aquatic organisms, especially colonies of coral.

Additionally, the proposed composition can provide a novel method for mitigating

undesirable, widely dispersed microorganisms such as Karenia brevis using hydrophobic or low solubility ingredients while improving penetration through an aquatic organism's plasma membrane or protective mucosal slime coating or via phagocytosis. Karenia brevis, commonly referred to as “Red Tide”, is the marine microorganism responsible for producing brevetoxins. The species is known to amass in colonies large enough to become visible from aerial observation usually possessing a characteristic red color giving rise to the blooms common name “Red Tide”. Other harmful algal blooms could also be targeted. The exact cause for algal blooms is often debated with eutrophication most commonly cited. During bloom events the quantity of brevetoxins released becomes concentrated, killing large biomasses of marine life. These events have a devastating effect on the Floridian economy which is affected two-fold as beaches and fisheries become void of life both human and marine alike. Economic losses due to Red Tide can and have resulted in losses in the billions of dollars.

The proposed composition can be deployed effectively in open or “wild” aquatic environments, such as the Ocean, and deliver targeted treatment to a wide area while remaining in suspension near the surface of the Ocean water. This provides an excellent way to deliver mitigating or lethal treatment to undesirable aquatic organisms such as Karenia brevis, or to other toxin producing blooms in the ocean or in lakes.

### SUMMARY

According to one aspect of the present invention, a method of delivering at least one active ingredient to a collection of aquatic organisms utilizes a self-micro-emulsifying or self-nano-emulsifying system. The self-emulsifying method includes a step of providing a volume of treatment that is stored in a housing, and a step of providing a collection of aquatic organisms immersed in a body of water and in contact with a mucosal layer that is positioned between the body of water and the collection of aquatic organisms. The self-emulsifying method includes the further steps of dispensing a first portion of the volume of treatment into the body of water, forming the first portion into a collection of sphericals semi-spontaneously when the first portion contacts the body of water, and contacting the mucosal layer with a second portion of the collection of sphericals. Each of the collection of sphericals comprises at least a first emulsifier, a second emulsifier different than the first emulsifier, and at least one active ingredient that has at least one of a hydrophobic, a lipophilic, or an oleophilic characteristic. When each of the collection of sphericals is within the body of water, each of the collection of sphericals has a first surface shaped like a sphere, and has a first diameter that is measured by laser diffraction, dynamic light scattering or microscopy using a volume distribution calculation. This collection of sphericals with their respective first diameters define a second average diameter by averaging the measurement of each of the first diameters together. Each of the collection of sphericals is self-micro-emulsifying or self-nano-emulsifying within the body of water. Each of the collection of sphericals is configured to contact or penetrate into the mucosal layer when in contact with the mucosal layer. The at least one active ingredient delivers a therapeutic property, a source of nutrition, or both to the collection of aquatic organisms when the second portion contacts or penetrates the mucosal layer.

According to another aspect of the invention, the second average diameter measures between a first range of 5 nanometers and 150 microns, preferably a second range of between 5 nanometers to 100 microns, and more preferably a third range of between 5 nanometers to 50 microns.

In another aspect of the invention, the volume of treatment is stored in the housing in a liquid state and has a first weight. Twenty five percent or less of the first weight is water.

In another aspect of the invention, the therapeutic property has at least one of an antibacterial, a taste deterrent, an antifungal, an antiviral, an antiprotozoal, an antiparasitic, an antiseptic, an anesthetic, an astringent, or an anti-inflammatory characteristic.

In another aspect of the invention, the source of nutrition is a digestible fat or a digestible oil.

In another aspect of the invention, the at least one active ingredient has a hydrophobic property or possesses a positive Octanol-Water Coefficient.

In another aspect of the invention, the body of water is confined within an aquarium or an isolation tank.

In another aspect of the invention, the housing is sealed such that the volume of treatment is not exposed to air during storage.

In another aspect of the invention, a majority of the collection of sphericals continue to hold each of the respective first surfaces in the spherical shape for at least 30 seconds, preferably at least 1 minute, preferably at least 2 minutes, preferably at least 5 minutes, preferable at least 10 minutes, preferably at least 15 minutes, preferably at least 20 minutes, most preferably at least 30 minutes.

In another aspect of the invention, the volume of treatment does not produce an anesthetic effect on the first organism.

In another aspect of the invention, the method includes the further step of delivering the sphericals to the collection of aquatic organisms topically.

In another aspect of the invention, the therapeutic property has at least one of an antibacterial, a taste deterrent, an antifungal, an antiviral, an antiprotozoal, an antiparasitic, an antiseptic, an astringent, or an anti-inflammatory characteristic. The at least one active ingredient has a hydrophobic property or possesses a positive Octanol-Water Coefficient. The collection of aquatic organisms comprises a first organism that is classified within the Class Chondrichthyes, and wherein the active ingredient is configured to provide the therapeutic property to the first organism.

In another aspect of the invention, the method includes the further step of delivering the sphericals to the collection of aquatic organisms topically, and the therapeutic property has at least one of an antibacterial, a taste deterrent, an antifungal, an antiviral, an antiprotozoal, an antiparasitic, an antiseptic, an astringent, or an anti-inflammatory characteristic. The at least one active ingredient has a hydrophobic property or possesses a positive Octanol-Water Coefficient and the collection of aquatic organisms comprises a first organism that is classified within the Class Chondrichthyes. The active ingredient is configured to provide the therapeutic property to the first organism.

In another aspect of the invention, the therapeutic property has at least one of an antibacterial, a taste deterrent, an antifungal, an antiviral, an antiprotozoal, an antiparasitic, an antiseptic, an astringent, a toxic, or an anti-inflammatory characteristic, and the at least one active ingredient has a hydrophobic property or possesses a positive Octanol-Water Coefficient. The collection of aquatic organisms comprises a second organism that is classified within the Class Malacostraca, and the active ingredient is configured to provide the therapeutic property to the first organism.

In another aspect of the invention, the method includes the further step of delivering the sphericals to the collection of aquatic organisms topically. In addition the therapeutic property has at least an antibacterial, a taste deterrent, an antifungal, an antiviral, an antiprotozoal, an antiparasitic, an antiseptic, an astringent, a toxic, or an anti-inflammatory characteristic, and the at least one active ingredient has a hydrophobic property or possesses a positive Octanol-Water Coefficient. The collection of aquatic organisms comprises a second organism that is classified within the Class Malacostraca, and the active ingredient is configured to provide the therapeutic property to the second organism.

In another aspect of the invention, the collection of aquatic organisms comprise a third organism that is classified within the class Anthozoa, and active ingredient is configured to provide the therapeutic property to the third organism.

In another aspect of the invention, the therapeutic property has at least one of an antibacterial, a taste deterrent, an antifungal, an antiviral, an antiprotozoal, an antiparasitic, an antiseptic, an astringent, or an anti-inflammatory characteristic, and the source of nutrition is a digestible fat or a digestible oil. In another aspect of the invention, the at least one active ingredient has a hydrophobic property or possesses a positive Octanol-Water Coefficient, and the collection of aquatic organisms comprise a third organism that is classified within the Class Anthozoa. In addition, the active ingredient is configured to provide the therapeutic property to the third organism.

In another aspect of the invention, the therapeutic property has at least one of an antibacterial, a taste deterrent, an antifungal, an antiviral, an antiprotozoal, an antiparasitic, an antiseptic, an astringent, or an anti-inflammatory characteristic, and the source of nutrition is a digestible fat or a digestible oil. In addition, the at least one active ingredient has a hydrophobic property or possesses a positive Octanol-Water Coefficient, and the collection of aquatic organisms comprise a fourth, fifth, sixth, seventh, eighth or ninth organism that is classified within the following Classes; Amphibia, Bivalvia, Cephalopoda, Gastropoda, Mammalia (Marine Only), Reptilia. In addition, the active ingredient is configured to provide the therapeutic property to the fourth, fifth, sixth, seventh, eighth or ninth organism.

In another aspect of the invention, the at least one active ingredient has a toxic characteristic on a target organism and has a hydrophobic property or possesses a positive Octanol-Water Coefficient. The target organism is a marine or freshwater cyanobacteria within the Class Cyanophyceae.

In another aspect of the invention, the at least one active ingredient has a toxic characteristic on a target organism and has a hydrophobic property or possesses a positive Octanol-Water Coefficient. The target organism is a marine or freshwater dinoflagellate within the Class Dinophyceae.

In another aspect of the invention, A method of delivering at least one active ingredient to toxins produced by a collection of aquatic organisms utilizing a self-micro-emulsifying or self-nano emulsifying system. The self-emulsifying method includes a step of providing a volume of treatment stored in a housing and a step of providing a collection of aquatic organisms immersed in a body of water that produce an aquatic toxin that is released into the body of water. The self-emulsifying system includes the further steps of dispensing a first portion of the volume of treatment into the body of water, forming the first portion into a collection of sphericals when the first portion contacts the body of water and contacting the aquatic toxin with a second portion of the first portion of the collection of sphericals. Each of the collection of sphericals comprises at least a first emulsifier, a second emulsifier different than the first emulsifier, and at least one active ingredient that has at least one of a hydrophobic, a lipophilic, or an oleophilic characteristic. When each of the collection of sphericals is within the body of water, each of the collection of sphericals has a first surface formed in the shape of a sphere, and has a first diameter that is measured by laser diffraction, dynamic light scattering or microscopy using a volume distribution calculation, which defines a second average diameter by averaging the measurement of each of the first diameters together. Each of the collection of sphericals is self-micro-emulsifying or self-nano-emulsifying within the body of water. The active ingredient is configured to at least partially chemically inhibit or sequester the aquatic toxin when in contact with the aquatic toxin.

In another aspect of the invention, the collection of aquatic organisms is Karenia brevis, and the aquatic toxin is a brevotoxin.

In another aspect of the invention, the active ingredient is benzalkonium chloride, castor oil, cedarwood oil, cinnamon, cinnamon oil, citric acid, citronella, citronella oil, cloves, clove oil, corn gluten meal, corn oil, cornmint, cottonseed oil, calcium hypochlorite, dried blood, eugenol, garlic, garlic oil, geraniol, geranium oil, lauryl sulfate, lemongrass oil, linseed oil, malic acid, peppermint, peppermint oil, 1-phenylethyl propionate, potassium sorbate, egg white solids, rosemary, rosemary oil, sesame, sesame oil, sodium chloride, sodium lauryl sulfate, soybean oil, spearmint, spearmint oil, thyme, thyme oil, turmeric, white pepper, or zinc.

### BRIEF DESCRIPTION OF THE DRAWINGS

For a fuller understanding of the invention, reference should be made to the following detailed description, taken in connection with the accompanying drawings, in which:

FIG. 1 is an example of the Prior Art and illustrates a collection of aquatic organisms, namely a first colony of coral, that is immersed in a first body of water within a first vessel or tank, with a first housing that contains a volume of pre-emulsified oleophilic droplets forming a collection of formed droplets wherein a first portion of the volume of pre-emulsified droplets are being dispensed into the first body of water.

FIG. 2 is a further illustration of the Prior Art depicted in FIG. 1, and depicts the same first body of water, first colony of coral, first vessel or tank, first housing, and first portion, and in addition, a first enhanced view of one of the formed droplets off to the right of the illustration depicts the first organized phase of the formed droplet which protects a first active ingredient prior to being immersed into the first body of water, as well as a second enhanced view off to the left of a first disorganized phase of the formed droplet after being immersed into the first body of water.

FIG. 3 is a further illustration of the Prior Art depicted in FIGS. 1 and 2, and depicts a section of the colony of coral illustrated in FIG. 1, with a third enhanced view of a first adult coral polyp that is positioned on an exterior surface of the first colony of coral of FIG. 1, and a fourth enhanced view of the first adult coral polyp that illustrates the first disorganized phase of one of the formed droplets of the collection of the pre-emulsified droplets of FIG. 1 contacting a first mucosal layer that is positioned between a first collection of cells of the first adult coral polyp and the first body of water, thereby illustrating the difficulty of the first disorganized phase of the formed droplet to deliver the first active ingredient to a first cell of the first adult coral polyp.

FIG. 4 illustrates a different second colony of coral and a fish immersed in a different second body of water within a different second vessel or tank, with a different second housing holding a volume of treatment within a pipette that dispenses a second portion of the volume of treatment into the second body of water, which semi-spontaneously form a collection of sphericals in the second body of water.

FIG. 5 illustrates the same second body of water, the pipette, the second colony of coral, the volume of treatment, and the second portion as illustrated in FIG. 4, with a fifth enhanced view on the right that depicts a second disorganized phase of a collection of ingredients of the second portion prior to being immersed into the second body of water, and a sixth enhanced view on the left that depicts the first portion semi-spontaneously forming a collection of sphericals when immersed into the second body of water.

FIG. 6 illustrates a different second section of the second colony of coral depicted in

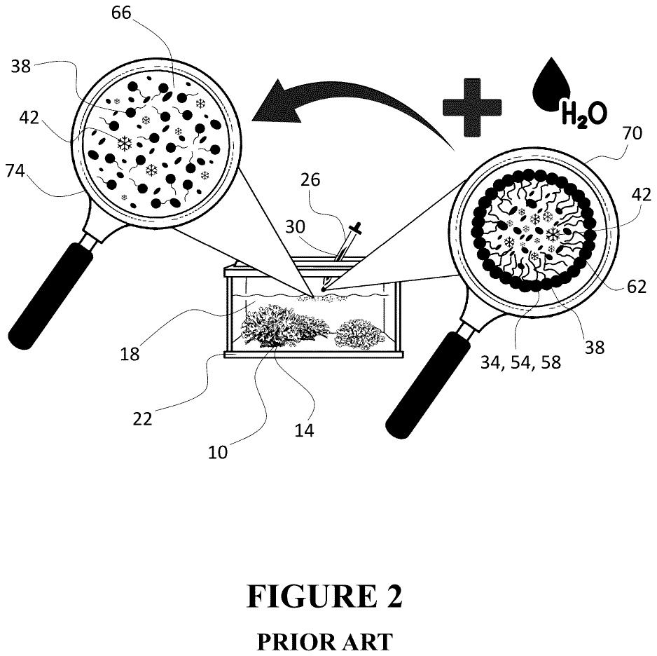

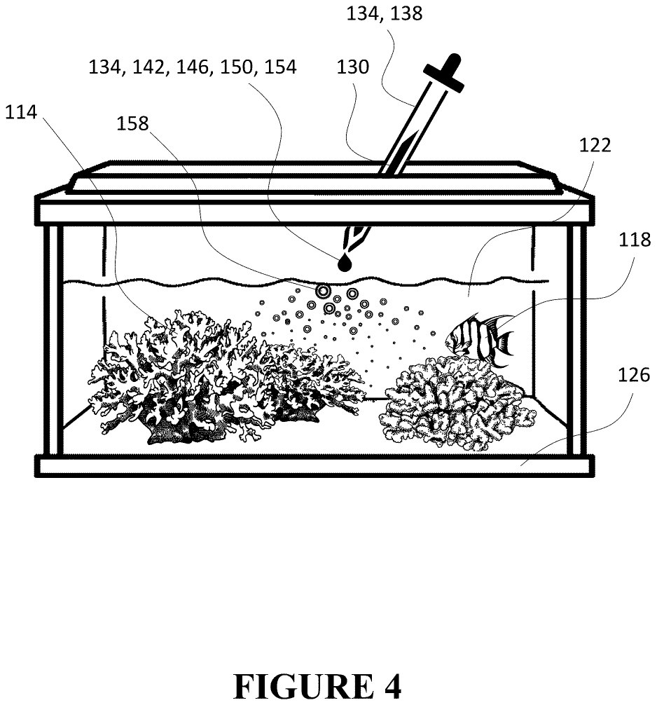

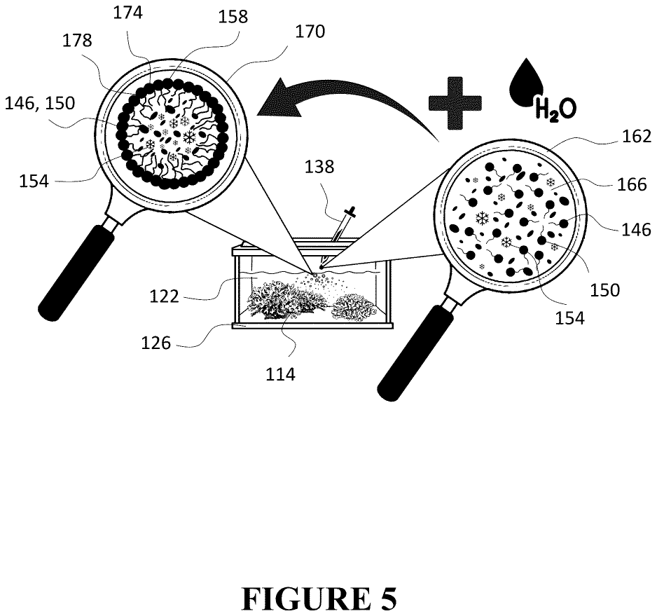

FIG. 4, with a seventh enhanced view of a different second adult coral polyp that is positioned on a different second surface of the colony of coral of FIG. 2, and an eighth enhanced view of the second adult coral polyp that illustrates one of the collection of sphericals of FIGS. 4 and 5 contacting a different second mucosal layer that is between a different second collection of cells of the second adult coral polyp and the second body of water of FIG. 2, thereby illustrating the relative ease of penetrating the second mucosal layer and delivering the at least one second active ingredient of the collection of sphericals to one of the second cells of the second collection of cells.

FIG. 7 illustrates an exemplary method of using the collection of sphericals similar to those of FIGS. 4-6 to combat “Red Tide”. The visible red tinting of Karenia brevis blooms is first utilized to identify large blooms from sea, boat, or land. An aquatic vessel, namely a boat, is delivered to a body of water that has an algal bloom present, specifically Karenia brevis. A composition including at least one treatment ingredient, an emulsifier, and a coemulsifier are dispensed into the body of water that form sphericals when exposed to bodies of water, forming sphericals which are ideally suited to help kill or mitigate Karenia brevis blooms, similar to the collection of sphericals found in FIGS. 4-6. The composition may be dispersed in a variety of ways, including by hand or using dispensing machinery to “spray” the composition directly to the surface of the body of water that harbors the Karenia brevis bloom.

### DETAILED DESCRIPTION

This disclosure will be broken into two informal sections. The first section will be a more general conversation about the disclosure that may reference the FIGS., but does not describe the drawings in great detail. In the second section, each of the FIGS. is addressed in careful detail to avoid any potential confusion about the scope and bounds of the claimed invention.

In one embodiment, the ability to effectively treat undesirable organisms such as bacterial or viral infections in aquatic environments including aquariums is often limited by the active ingredient's solubility in fresh or saltwater conditions. Further, due to their solubility, current treatments utilizing hydrophilic active ingredients treat the entire aquatic environment, driving the use of separate vessels, also known as “quarantine vessels.” This solubility issue also makes wild treatment of aquatic organisms using the dipping methods nearly impossible.

In the few prior art cases where hydrophobic ingredients are utilized for aquatic organism treatments, vast quantities of emulsifiers are employed to change the aquatic environment's surface tension, overall polarity, etc. to allow the ingredients to become mixable or soluble with the surrounding water. Doing so often has a detrimental effect upon the aquatic organism's barrier protections like mucosal slime coatings. This can result in inflicting more stress and harm to the targeted organism when compared to the good of the treatment. Secondly, the requirement to change the environment's surface tension, overall polarity, etc. to facilitate the ingredients to become mixable or soluble in the body of water results in the near inability to utilize this method in large or wild environments, such as a lake or ocean.

One well-known example of when aquatic organism treatment is desirable is during the relocation of aquatic organisms in order to ensure they do not carry undesirable “hitchhiker” species with them to their new locations. A vast number of species including bacterial and viral are known to live on or around coral colonies, live rock, and encrusted submerged structures, some of which can be detrimental to their transplanted habitat. The unwanted introduction of these species is a common concern during transportation. To minimize undesirable species introduction, a method known as “dipping” is often utilized.

Within this body of work, “dipping” is referred to as the act of submerging the desired organism into a confined body of water which has been treated with bactericidal or virucidal ingredients for a short period of time, generally under 15 minutes. Time rarely extends beyond a few minutes as the bactericidal or virucidal solution is often deadly to desirable species if allowed enough exposure time. The specimen may then be removed from the bactericidal or virucidal solution and introduced into its desired new location with concerns of undesirable species introduction effectively minimized.

A similar practice is often utilized to treat infected coral colonies located in aquarium systems. In this instance, the prior art “dip” method is utilized to treat aquatic species known to be experiencing an ailment, rather than utilizing the prior art method as simply a preventative safety measure to avoid or reduce the introduction of unknown undesirable species into a new body of water used to house aquatic organisms such as colonies of coral.

In some instances, the dipping method is utilized to attempt to provide ample nutrients to a targeted species rather than to rid undesirable organisms. By providing a nutrient-concentrated isolated environment, the targeted undernourished organism(s) may be treated without disturbing the homeostasis of its primary aquarium or environment.

In all “dipping” instances described, the nutrient or treatment active ingredients often exhibit poor solubility in either fresh or saltwater environments. This limits both the active ingredients available and their maximum concentration to their solubility limits unless a potentially harmful quantity of surfactants or emulsifiers are utilized.

In the proposed inventions their primary purpose is to increase concentrations of low solubility ingredients beyond their solubility limits in aquatic environments and provide a means of adhering or penetrating an aquatic organism's protective plasma membrane or mucosal slime coating or providing treatment through active ingestion of concentrated doses. Doing so opens the door to treating aquatic organisms using active ingredients that would otherwise possess aquatic concentrations too dilute to be effective. These techniques may be utilized in either quarantined “dipping” environments, main aquarium systems, or in some cases wild treatment.

In another embodiment, former methods of providing treatment to aquatic organisms located in wild or open bodies of water such as Oceans or lakes are ineffective, inefficient, or both. In one form of treatment, the composition is utilized to kill or mitigate the growth of Karenia brevis or other undesirable toxin producing microorganisms and/or algal blooms. In a broader application, one form of treatment can be applied to mitigate any member of the genus Karenia. When Karenia brevisgrows in colonies in the open ocean as a freely dispersed microorganism, mitigation is extremely difficult. This is because obtaining the active ingredient concentration required to achieve mitigation through solubility alone would either be impossible when active ingredient solubility limits are low or require vast quantities of active ingredient as the concentration is continually dissipated in the open ocean environments. Often Karenia brevis blooms and other similar toxin producing blooms congregate near the surface of the open body of water. This reduces the effect of any treatment delivery device that does not have the ability to stay suspended near the surface of the water.

In response to the need to help mitigate algal blooms, the currently disclosed method of producing and dispensing the disclosed composition provides a novel method for delivering droplets to protect and contain concentrated active ingredients from the surrounding body of water until in contact with a plasma membrane or a mucosal layer of an undesirable microorganism. The protective droplet exterior opens to deliver the concentrated active ingredient to the undesirable microorganism. In this embodiment, the treatment is an active ingredient that kills or mitigates Karenia brevis. The active ingredient is protected within a sphere formed by an emulsifier and a coemulsifier, which allows the active ingredient to stay undiluted in the currents of the bodies of water, and allows the active ingredients to stay in contact with the algal blooms such as Karenia brevis in the portion of the body of water that is near the surface. These features tend to make the deployment of the novel composition more effective at treating toxin producing algal blooms better than former methods.

These newly disclosed techniques have never before been utilized to treat aquatic organisms. In this embodiment their primary purpose is to increase the concentrations of ingredients at targeted localized locations within an aquatic environment while simultaneously providing methods to penetrate an aquatic organism's plasma membrane or mucosal slime coating to promote active ingestion of treatment, nutrition, or both. In at least one embodiment, the treatment tends to kill or mitigate the undesirable aquatic microorganism.

In traditional emulsifying techniques, the emulsified hydrophobic droplets are completely dependent on the ratio of hydrophobic to hydrophilic ingredients, meaning emulsifier concentration must be scaled to match the body of water or the droplets will be destroyed. This cannot be effectively accomplished in large aquatic ecosystems or aquariums as the quantity of emulsifiers required would destroy the aquatic ecosystem. Within the self-emulsifying or encapsulation systems described herein, the body of water they are added to has little effect on the successful delivery of the poorly water-soluble active ingredients.

Corals are marine invertebrates from the phylum Cnidaria which also includes jellyfish, anemone, and hydroids. Corals as the general public tends to understand them are actually colonies of coral composed of individual animals known as coral polyps. These individual polyps filter feed from the surrounding seawater using tentacles and a mouth. Hard corals even have shared tissue between polyps known as the coenosarc which allows them to distribute nutrients throughout the entire coral colony as needed.

Beneath the fleshy coral tissue lies a skeleton of calcium carbonate that is created by the coral's excrement and is shared among the colony. These continuously growing skeletons are the building blocks of coral reefs and are the reason why corals are so valuable to the ocean's ecosystems.

Like all animals, corals are susceptible to a variety of ailments including viruses, infections and other diseases. These ailments are often influenced by environmental factors and can be bacterial, viral, fungal, or otherwise influential to the corals'ability to obtain essential nutrients and/or requirements for healthy functioning. Once a coral experiences one form of ailment they become immunocompromised and are therefore susceptible to further infection. However, there are very few treatment options available for corals who become ailed with disease or infection. Some of these ailments include but are not limited to, black band disease (BBD), white band disease (WBD), white plague, stony coral tissue loss disease (SCTLD), brown jelly disease (BJD), and brown Ciliates.

Corals also share a symbiotic relationship with a photosynthetic organism collectively known as zooxanthellae, a microscopic alga, which live in the tissue of the coral polyps and provide the corals with nutrients obtained from photosynthesis in exchange for shelter within the coral colony. Zooxanthellae also contribute to the color that most people associate with coral. These zooxanthellae require specific temperatures and amounts of light to function which in turn impacts the health of the coral host. For example, if temperatures get too high, the coral will expel its zooxanthellae giving the tissue a white appearance and will enter a vulnerable state of minimized metabolism known as coral bleaching. During coral bleaching, the coral polyps are not receiving the proper nutrients and are therefore particularly susceptible to other ailments such as coral disease and viral or fungal infections.

Other aquatic creatures such as manatees and sea turtles are susceptible to viruses and to diseases which can cause lesions on the tissue which are generally left untreated. Manatees in particular are often struck by boat propellers which leave large gashes in their flesh which become prone to infection. Sharks, rays and other aquatic animals often receive cuts from bumping into the reef or from battling with their prey or other predators. These wounds can be fatal if left untreated.

In at least one embodiment, the proposed invention seeks to treat aquatic animals such as but not limited to those within the following classes; Amphibia, Anthozoa, Bivalvia, Cephalopoda, Chondrichthyes, Gastropoda, Malacostraca, Marine Based Mammalia, microorganisms, and Reptilia that are at least partially submerged in an aqueous environment. In at least one embodiment, the proposed invention seeks to treat aquatic organisms such as toxin producing algae.

In at least one embodiment, the intent of the invention is to provide a superior method of treating aquatic organisms in either a quarantine vessel or their permanent environment, both natural and artificial (i.e. aquariums) using hydrophobic active ingredients. As depicted in FIGS. 4-7, this disclosure provides a method to encapsulate hydrophobic ingredients within a hydrophilic perimeter shell without the need for excessive external mechanical energy. The encapsulation happens semi-spontaneously in the presence of water and low energy like the low energy or agitation found naturally occurring in water currents. The encapsulation occurs when the composition (the disclosed invention) is added to a volume of water which is at minimum 4 times the volume of composition added. The maximum dilution or maximum volume of water the composition may be added to while still creating the semi-spontaneous encapsulations of the at least one active ingredient is unconstrained.

Once formed, the encapsulated sphericals made from the newly proposed compositions will maintain their integrity. To be more specific a majority of the collection of sphericals will continue to hold each of the respective first surfaces in the spherical shape for at least 30 seconds, preferably at least 1 minute, preferably at least 2 minutes, preferably at least 5 minutes, preferable at least 10 minutes, preferably at least 15 minutes, preferably at least 20 minutes, most preferably at least 30 minutes.

The encapsulated sphericals average size are typically below 250 micrometers in diameter as measured by means of laser diffraction, dynamic light scattering or microscopy using a volume distribution calculation. The encapsulated sphericals are intended to freely disperse amongst the water column. Beneficial or desired effects may occur either through ingestion or by direct topical contact with a targeted species.

Composition of the invention requires the use of at least two ingredients which may be classified as emulsifiers or surfactants, often labeled emulsifier and coemulsifier. The composition must also possess at a minimum one hydrophobic ingredient comprising an oleophilic and/or a lipophilic and/or a glyceride structure which may or may not be the active ingredient itself. The composition must also contain at least one active ingredient which may be described as hydrophobic or possess a positive “Log P” or “Log D” value where “Log P” is described as the “Log of the Partition Coefficient” or the “Log of the Distribution Coefficient” of the molecule in question where in the partition solvent is Octanol.

Active ingredients or active agents can include any compounds that can provide or deliver an antiviral, antiseptic, antiprotozoal, antibacterial, antiparasitic, anesthetic, toxic, or anti-inflammatory characteristic to the composition or compositions. Active agent ingredients preferably come from natural sources that, in at least one embodiment, may be effective against the targeted infection/disease. These compounds can be adjusted as needed in order to create the best treatment for the infection/disease that is being treated.

Active ingredients or active agents may also be nutrients or even replacement symbionts such as zooxanthellae to help maintain coral health or to assist coral colony survival chances during bleaching events. For example, the active agent in the composition may include fats or oils to provide an alternate source of food to the colony especially during a stressing event.

Encapsulation of the hydrophobic active ingredients within a shell characterized by a hydrophilic exterior possessing a total diameter of less than 250 micrometers in the presence of an aqueous environment of at least 4 times the total volume of the encapsulated sphericals leads to a successful outcome in most applications.

Nearly all aquatic organisms (targeted or otherwise) possess an outer plasma membrane or mucosal layer or coating on their exterior commonly referred to as a “slime coat”. This slime coat is vital to their survival for multiple reasons including serving as a barrier to prevent foreign objects and microorganisms from taking hold and causing harm. Therefore, keeping it intact and in healthy condition is paramount to an organism's overall health.

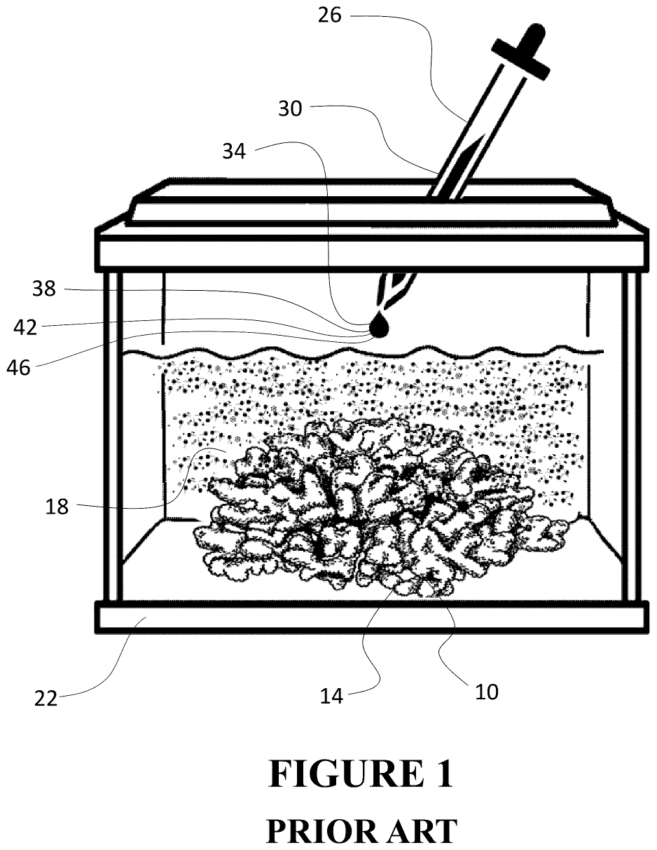

As generally depicted in Prior Art FIGS. 1-3, many coral and fish “dips” are commercially available and are designed to rid ailing organisms of external pests and microorganisms. These dips often utilize essential oils and other hydrophobic ingredients as active ingredients. To ensure the hydrophobic ingredients are incorporated into the water column rather than remain floating on the surface, a large concentration of surfactants are often utilized. The amount of surfactants utilized in prior art methods is enough to change the water chemistry factors such as surface tension and polarity to facilitate the hydrophobic ingredients to become mixable or soluble within the water column.

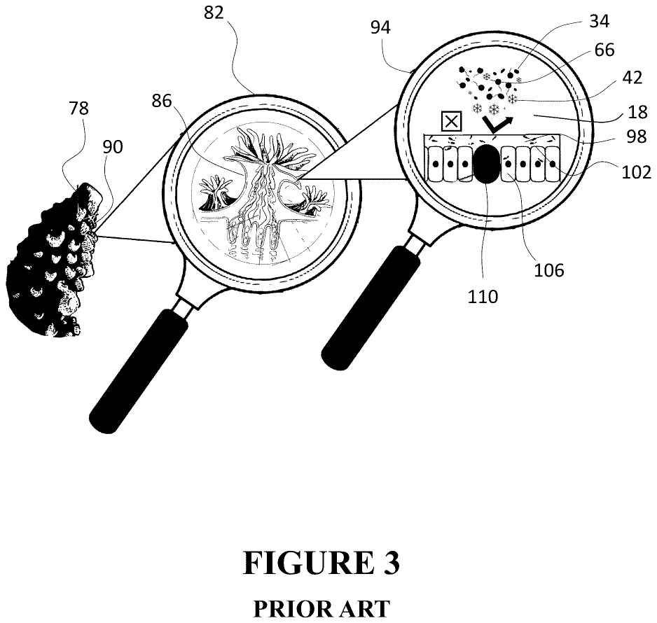

Depicted in FIG. 1, if the entire water column is not modified, the hydrophobic active ingredients will quickly separate from the surfactants and subsequently rise to the surface out of the water column. However, changing factors such as surface tension and polarity of the entire water column has negative effects on all organisms contained within it and often results in death of the organisms if left within the modified environment for more than a few minutes. Further, even if the environment is modified enough to allow the hydrophobic ingredients to become mixable but not enough to interrupt an organism's protective outer mucosal slime coat, the hydrophobic active ingredients will be repelled by the mucosal coating and fail to gain the penetration that is required to appropriately treat an organism as depicted in FIG. 3.

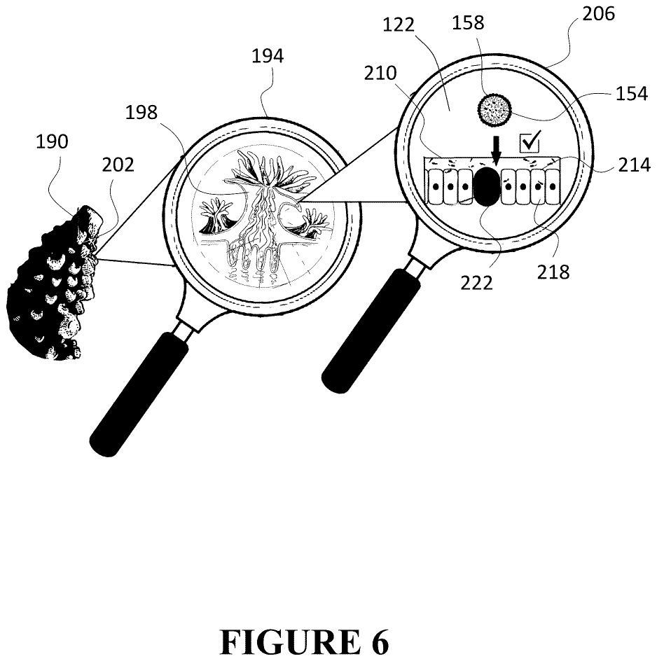

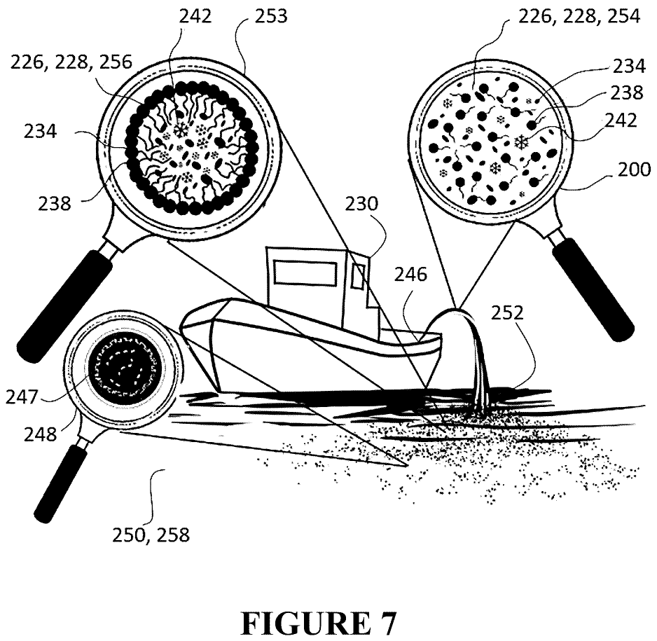

FIG. 6 provides an understanding of how the self-encapsulated spheres depicted in FIGS. 4-7 interact with a targeted organism. This is why many of the competing prior art products are marketed as “dips” and treatments are always conducted in small quarantine vessels with the ailing organism quickly “dipped” into the modified environment for short periods of time before being returned to an ideal environment.

Depicted especially in FIG. 4, the proposed invention does not require any changes to the water column to incorporate hydrophobic ingredients, ensuring that a continuously ideal environment is maintained during treatment. Therefore, all organisms, both targeted and not targeted are not stressed during the treatment process. However, when possible, it is still advisable to perform treatments in a temporary or quarantine vessel unless the hydrophobic active ingredient is known to be harmless to non-targeted organisms. This is because the unique structure of the invention provides the hydrophobic active ingredient(s) a method of transport into the water column. FIG. 5 depicts how and why this is possible.

A detailed understanding of how the invention transports and delivers hydrophobic active ingredients into a targeted organism may be understood in FIG. 6. FIG. 6 provides an understanding of how the self-encapsulated spheres depicted in FIGS. 4 and 5 interacts with a targeted organism. Due to the presence of their characteristic outward facing hydrophilic perimeter, the encapsulated sphericals are not repelled by an organism's mucosal slime coating so that it may be delivered to the target tissue of the aquatic organism. That is, the hydrophilic perimeter makes it easier to contact the target organisms.

In at least one embodiment, one of the novel compositions provides an excellent way to deliver an active ingredient to a bloom of Karenia brevis located near the surface of an open body of water such as an Ocean or a lake. When Karenia brevis forms in large colonies near the surface of open bodies of water and diffuses sufficient brevotoxins, the water takes on a red color, which inspired the term “Red Tide” to describe the large Karenia brevis colony formations. These formations are toxic to both aquatic life and human life.

Red Tides can be quite enormous and sometimes can even be observed from satellites in outer space. Karenia brevis produce and shed brevetoxins upon their death, upon being subjected to stressor events, and even during various portions of their life cycle even in the absence of a stressing event. This means that during Red Tides, an enormous amount of brevetoxins are present.

Brevotoxins are aquatic toxins that can kill or injure aquatic life, and commonly cause rashes and respiratory issues in humans. It follows that when Red Tides form on beaches, the brevetoxins kill massive amounts of aquatic life, and humans cannot safely swim in the water. These Red Tides have cost the state of Florida alone billions of dollars in harm to the local fisheries and the otherwise burgeoning tourist industry. Although Red Tides and brevetoxins are the most well-known of the aquatic toxins, many other forms of aquatic life such as those in the Class Cyanophyceae also can create blooms of other harmful aquatic toxins. These aquatic toxins can include but are not limited to Microcystins, Nodularins, Cylindrospermopsin, and BMAA (β-Methylamino-L-alanine), Saxitoxins, Okadaic Acid and Dinophysis Toxins, Domoic Acid, Prymnesins, and/or Anatoxins.

Since Karenia brevis is a dinoflagellate with the class Dinophyceae capable of movement, the Red Tides are typically suspended in the body of water near the surface during the daytime, and more deeply sunk during the nighttime. The brevetoxin is evenly spread, dissolved and dispersed widely into the water column that surrounds the Karenia brevis. This makes targeting the brevetoxins with treatment directly more difficult. Another challenging factor is that Red Tides typically form in non-confined bodies of water such as the Ocean or at a river's mouth.

In at least one embodiment, a composition of the active ingredient, the emulsifier, and the coemulsifier are stored together with no more than 25% water by weight. This composition is then dispensed onto surfaces of open bodies of water that have high concentrations of Red Tide or other undesirable blooms. Similar to the composition that is used to provide nutrition or a beneficial treatment to aquatic organisms such as the colonies of coral, the emulsifier and the coemulsifier together form a sphere around the active ingredient when the composition is immersed in a large body of water. In this embodiment, the active ingredient includes a treatment to kill or mitigate the undesirable aquatic organism, in this case, Karenia brevis.

The composition chronologically begins stored in a compact fashion in a first phase with no more than 25% water by weight of the stored composition. The composition does not form into spheres around the active ingredient but is stored disorganized. The composition is then dispensed into an open body of water that may include a high density of Red Tide. When the composition is immersed in relatively large bodies of water, the emulsifier and the coemulsifier semi spontaneously form sphericals around the active ingredient, forming small capsules or sphericals that are small enough to remain suspended in a water column of the body of water near the surface. This formation of the sphericals defines the organizational phase. These sphericals, since they also have an outer perimeter that is not repulsed by the plasma or mucosal membrane of the targeted undesirable organism, can deliver the active ingredient to the targeted undesirable organism such as Karenia brevis with relative ease. This delivery of the active ingredient to the Karenia brevis or other targeted undesirable organism is made easier because of the relatively long period of time afforded by the small size of the sphericals to remain in suspension in the same water column as the targeted undesirable organism.

This method of mitigating Karenia brevis can be achieved with a relatively small volume of composition, with a great deal of the active ingredient reaching the targeted organism in a relatively short period of time. The active ingredient can be a toxin or an inhibitor of growth to the targeted organism. That is, the second composition is not designed to help the aquatic organism; rather it is intentionally designed to harm or kill the undesirable organism. In at least one embodiment, the composition includes a dye that is visible in water. This provides an easy and reliable way to establish that the composition has been applied to the desired target areas in the body of water. It follows that as the undesirable organism such as Karenia brevis is killed, the Red Tide will be killed or mitigated as a result.

In another embodiment, the active ingredient is an ingredient that is selected not to reduce or eliminate the toxicity of the aquatic organism, but to inhibit the toxicity of the toxins, or sequester the toxins produced by the aquatic organism. In a more specific embodiment, the active ingredient is an ingredient that is configured to reduce or eliminate the toxicity of the toxins produced by the aquatic organism Karenia brevis. To be clear, in this embodiment, the treatment does not have to deliver the active ingredient, through a plasma membrane or a mucosal layer that protects an aquatic organism. The sphericals that protect the delivery of the active ingredient still serve a valuable purpose of providing a way to better assure that the active ingredient remains suspended in the water column near the highest density of the toxins formed by floating aquatic organisms such as Karenia brevis. In addition, the sphericals serve to preserve the active ingredient in the body of water longer than if the ingredient was dispensed without the benefit of the protection of the spherical's protective surface. In an even more specific example, the active ingredient can be configured to chemically interact with the brevotoxin produced and released by Karenia brevis in order to inhibit, or sequester the toxins.

Active ingredients may include but are not limited to: castor oil, cedarwood oil, cinnamon, cinnamon oil, citric acid, citronella, citronella oil, cloves, clove oil, corn gluten meal, corn oil, cornmint, cottonseed oil, calcium hypochlorite, dried blood, eugenol, garlic, garlic oil, geraniol, geranium oil, lauryl sulfate, lemongrass oil, linseed oil, malic acid, peppermint, peppermint oil, 1-phenylethyl propionate, potassium sorbate, eg white solids, rosemary, rosemary oil, sesame, sesame oil, sodium chloride, sodium lauryl sulfate, soybean oil, spearmint, spearmint oil, thyme, thyme oil, turmeric, white pepper, or zinc.

Regarding Prior Art FIG. 1, a collection of aquatic organisms 10, namely a first colony of coral 14, is immersed in a first body of water 18 within a first vessel or tank 22. A first housing 26 contains a first solution 30 that comprises a volume of pre-emulsified oleophilic droplets which form a collection of formed droplets 34. The formed droplets 34 comprise a first emulsifier 38, and an at least one first active ingredient 42 with a hydrophobic characteristic. A first portion 46 of the first solution 30 is being dispensed into the first body of water 18.

Regarding Prior Art FIG. 2, the formed droplets 34 of the first solution 30 tend to maintain a first organized phase 54 during storage prior to being dispensed into the first body of water 18. The first organized phase 54 is a sphere-like shape 58 with a first emulsifier 38 forming a first exterior 62 that protects the first active ingredient 42 that is generally surrounded by the first emulsifier 38 when formed into the first organized phase 54. This first organized phase 54, if the shape can be maintained, can provide a way to protect the first active ingredient 42 while the formed droplets 34 travel toward the first colony of coral 14 to deliver the first active ingredient 42 to the first colony of coral 14 or other targeted collection of aquatic organisms 10. The first organized phase 54 of the formed droplets 34 is shown in the first enhanced view 70, and the first disorganized phase 66 is shown in the second enhanced view 74.

However, once the formed droplets 34 are immersed into the first body of water 18, the formed droplets 34 tend to change from the first organized phase 54 into a first disorganized phase 66 in a short period of time. The first disorganized phase 66 cleaves the first emulsifier 38 from the first active ingredient 42, thereby eliminating the first exterior 62 that initially protected the first active ingredient 42 while being delivered to the first colony of coral 14. Upon incorporation into the first body of water 18 the emulsifier 38 dilutes and the first organized phase 54 becomes unformed. The reason that the formed droplets 34 lose their first organized phase 54 quickly is due to the dilution of the emulsifiers upon entering the water. This dilution results in individual emulsifying molecules becoming too scarce to form an encapsulating structure. To cope with this, prior art methods often utilize large quantities of surfactants or solubilizers within small, quarantined tanks or vessels. While chemically similar to emulsifiers, surfactants differ by purpose. Where an emulsifying ingredient's purpose is help form droplets of non-miscible substances, surfactants alter surface tensions to help make non-miscible substances, miscible. However, changing the surface tension of the quarantine first body of water 18, negatively impacts the outer slime coating of any living organism within the quarantine first body of water 18 severely.

Regarding Prior Art FIG. 3, a first section 78 of the first colony of coral 14 illustrated in FIG. 1 is shown. A third enhanced view 82 depicts a first adult coral polyp 86 that is positioned on a first surface 90 of the first colony of coral 14. A fourth enhanced view 94 of the first adult coral polyp 86 illustrates one of the formed droplets 34 in the first disorganized phase 66 contacting a first mucosal layer 98 that is positioned on a second surface 102 between a first collection of cells 106 of the first adult coral polyp 86 and the first body of water 18. The fourth enhanced view 94 illustrates the difficulty of the formed droplets 34 to deliver the first active ingredient 42 to a first cell 110 of the first adult coral polyp 86 while in the first disorganized phase 66. One of the reasons that this delivery is more difficult is because the first mucosal layer 98 tends to repel the hydrophobic first active ingredient 42. Since the first active ingredient 42 experiences difficulty traversing the first mucosal layer 98, less of the first active ingredient 42 is successfully delivered to the first cell 110, thereby reducing efficacy of the overall prior art treatment method.

Prior Art FIGS. 1-3 depict the target collection of aquatic organisms 10 as the first colony of coral 14 which is covered by the first mucosal layer 98 that is positioned between the first colony of coral 14 and the first body of water 18. Adult coral polyps tend to be affixed to a stationary position and many coral larvae, but not all, are not affixed in a stationary position. Both coral larvae and adult coral polyps tend to be covered by their own mucosal layer similar to the first mucosal layer 98 disclosed in FIG. 3. Also, many coral larvae have a mouth (not shown) that can ingest an object no larger than 25 microns in diameter.

The first active ingredient 42 is hydrophobic and is fashioned to hopefully deliver a nutritional benefit and/or a therapeutically effective amount of an antibacterial, a taste deterrent, an antifungal, an antiviral, an antiprotozoal, an antiparasitic, an antiseptic, an anesthetic, an astringent, a toxic, or an anti-inflammatory characteristic to the targeted collection of aquatic organisms 10.

Still referring to FIGS. 1-3, the first body of water 18 is generally called a “dip” when formed droplets 34 of the first solution 30 are dispensed into the first body of water 18 which contains a certain amount of emulsifiers 38. This increase in emulsification in the first body of water 18 tends to keep the formed droplets 34 in the first organized phase 54 for a longer period of time. However, the presence of emulsifiers 38 alter physical properties, specifically surface tension, of the first body of water 18. This change in surface tension can disrupt or destabilize the first mucosal layer 98 such that the layer no longer effectively provides protection to the collection of aquatic organisms 10. As a result, the operator of prior art “dips” usually must pick up the first collection of aquatic organisms such as the first colony of coral 14, dip them into the first body of water 18 for a very short period of time, maybe only a few minutes, add the formed droplets 34 from the first solution 30, and then remove the first colony of coral 14 before the first mucosal layer 98 is damaged. This only provides a short window of time for the formed droplets 34 to reach the target collection of aquatic organisms 10.

Since modifying the first body of water 18 with surfactants or solubilizers introduced by the first solution 30 makes the delivery of the first active ingredient 42 from the formed droplets 34 more effective, the “dips” are usually limited to use in bodies of water similar to the first body of water 18, namely a first vessel or tank 22 that is small and man-made, such as an aquarium or an isolation tank. Attempting to deliver the first active ingredient 42 using the prior art method in the wild or open ocean, for instance, is significantly less effective because the wild ecosystems cannot be emulsified or solubilized effectively.

Generally regarding FIGS. 1-3, the prior art “dip” method to deliver active ingredients to aquatic organisms has some clear shortcomings. First, by relying on a composition of a single emulsifier to protect the at least one hydrophobic active ingredient, the formed droplets struggle to maintain their protective organized shape for a reasonable period of time without additional help, usually in the form of large quantities of surfactants. The resultant modification to the body of water's surface tension threatens the integrity of the mucosal layer that often protects many kinds of aquatic organisms, including adult coral polyps and coral larvae if the exposure continues for too long of a period of time. This also means that the “dip” strategy cannot work efficiently outside of a small man-made enclosure such as an aquarium, because the volume of water in the body of water is too much to modify with surfactants or solubilizers.

Current methods see the body of water altered through the addition of surfactants or risk the dip composition losing its organized sphere-like shape quickly, resulting in the hydrophobic active ingredient losing miscibility. In both cases, the active ingredient is not appropriately equipped to diffuse across a topical hydrophilic mucosal layer or barrier and is instead repelled.

Generally regarding FIGS. 4-7, the new method discloses a self-emulsifying encapsulation that comprises at least two emulsifiers and at least one hydrophobic active ingredient. When properly chosen the at least two emulsifiers have affinities towards one another upon entering a large quantity of water based upon their independent physiochemical attributes. As a result, the emulsifiers fit together similar to puzzle pieces in the presence of large quantities of water to form sphericals which active ingredients can be enclosed within. Once formed, they do not have an affinity for water the way single surfactant droplet formations do.

The stability of these sphericals in water also reduces the amount of emulsifier that ends up free floating in the body of water. Therefore, this method does not drastically impact the surface tension of the water. This leads to fewer impacts on the target aquatic organisms and their protective mucosal layer.

Since the sphericals have greater stability in water and have less impacts upon the surrounding body of water than prior art methods, the target aquatic organism may be exposed to the treatment and/or nutritional benefits for a longer period of time.

Regarding FIG. 4, a different second colony of coral 114 and a fish 118 are immersed in a different second body of water 122 within a different second vessel or tank 126, with a different second housing 130 holding a volume of treatment 134 within a pipette 138 that is used to dispense a second portion 142 of the volume of treatment 134 into the second body of water 122. The volume of treatment 134 comprises a second emulsifier 146, a third emulsifier 150, and at least one hydrophobic second active ingredient 154 which semi-spontaneously form a collection of sphericals 158 when immersed into the second body of water 122.

Regarding FIG. 5, the same second body of water 122, the pipette 138, the second colony of coral 114, the volume of treatment 134, and the second portion 142 are present as was illustrated in FIG. 4. In addition, a fifth enhanced view 162 (on the right side of the illustration) depicts an initial second disorganized phase 166 of the composition of ingredients 146, 150, 154 of the second portion 142 prior to being immersed into the second body of water 122. Unlike the “dip” method, the composition of ingredients 146, 150, 154 stores in the second disorganized phase 166. In a sixth enhanced view 170 (on the left side of the illustration) that depicts the second portion 142 semi-spontaneously forming the collection of sphericals 158 when immersed into the second body of water 122 in a second organized phase 174. The collection of sphericals 158 have a second exterior 178 that protects the at least one second hydrophobic active ingredient 154 and form substantially into the shape of a sphere (see FIG. 5). Although the second emulsifier 146 and the third emulsifier 150 together generally envelop the at least one second active ingredient 154 there is no limitation or requirement that the second exterior 178 must fully surround or encapsulate the at least one second active ingredient 154 from the second body of water 122.

Each of the collection of sphericals 158 has a first diameter 182 (not shown) that is measured by laser diffraction, dynamic light scattering or microscopy using a volume distribution calculation. The average of these first diameters 182 together define a second average diameter 186 (not shown) of the collection of sphericals 158. Each of the collection of sphericals 158 is self-emulsifying when immersed in the second body of water 122.

Regarding FIG. 6, a different second section 190 of the second colony of coral 114 that is depicted in FIG. 4 is shown. A seventh enhanced view 194 illustrates a different second adult coral polyp 198 that is positioned on a different third surface 202 of the second section 190 of the second colony of coral 114 depicted in FIG. 4. In an eighth enhanced view 206, the second adult coral polyp 198 has a second mucosal layer 210 on a fourth surface 214, the second mucosal layer 210 is positioned between the second body of water 122, and a second collection of cells 218 that are a part of the second adult coral polyp 198. In the second body of water 122 one of the collections of sphericals 158 is illustrated as delivering the at least one second active ingredient 154 to the second mucosal layer 210 and ultimately to a second cell 222 of the second collection of cells 218 of the second adult coral polyp 198.

Since each of these collections of sphericals 158 is relatively stable in water, the second emulsifier 146 and the third emulsifier 150 of the second exterior 178 make the process of contacting and later penetrating a second mucosal layer 210 easier, because the hydrophobic at least one second active ingredient 154 is generally enveloped by the second exterior 178. This in turn makes the diffusion of the at least one second active ingredient 154 into the target collection of aquatic organisms easier when compared to the prior art “dip” method.

The at least one second active ingredient 154 is configured to deliver a therapeutic

property or a source of nutrition to the targeted collection of aquatic organisms 10 when the at least one second active ingredient 154 penetrates the second mucosal layer 210. The at least one second active ingredient 154 has a hydrophobic property or possesses a positive Octanol-Water Coefficient.

Due to the nature of ingredients 146, 150, 154 that form the new composition, the volume of treatment 134 (see FIG. 4) is stored in the second housing 130 in a liquid state and has a first weight (not shown), and has a composition such that 25% or less of the first weight is water (not shown). This tends to lead to a more compact storage profile than the prior art “dips” method can achieve.

Regarding the collection of sphericals 158 (see FIGS. 4-7), in at least one embodiment, the second average diameter 186 measures between a first range of 5 nanometers and 150 microns, preferably a second range of between 5 nanometers to 100 microns, and more preferably a third range of between 5 nanometers to 50 microns. This is believed to facilitate the ingestion of the at least one second active ingredient 154 by coral larvae.

In at least one embodiment, the second body of water 122 is confined within an aquarium or a quarantine vessel such as the exemplary second vessel or tank 126 of FIG. 4. In at least one embodiment, the second body of water 122 has a first volume that is between a range of four to ten times a second volume of the first portion 46 (see FIG. 4). In at least one embodiment, the second housing 130 is sealed such that the volume of treatment 134 is not exposed to air during storage.

In at least one embodiment, the source of nutrition is a digestible fat or a digestible oil. In at least one embodiment, a majority of the collection of sphericals 158 continue to hold their second organized phase 174, namely a spherical shape, for at least 15 minutes, preferably at least 20 minutes, most preferably at least 30 minutes after being immersed in the second body of water 122.

In at least one embodiment, the volume of treatment 134 does not produce an anesthetic effect on the target collection of aquatic organisms 10. In at least one embodiment, the collection of sphericals 158 can be applied topically to the second mucosal layer 210. Herein the term “topically” is defined as having contact to outer facing mucosal or barrier layer which separates the targeted organism from the water in which the organism is immersed.

By utilizing this self-emulsifying encapsulated delivery method, aquatic organisms can be treated more effectively than the prior art “dip” methods, especially with respect to adult coral polyps and coral larvae.

Regarding FIG. 7, in a ninth enhanced view 200, a second composition 226 having a third weight 228 is initially stored on a vessel such as a boat 230 that comprises at least one fourth emulsifier 234, at least one fifth emulsifier 238 different from the at least one fourth emulsifier 234, at least one third active ingredient 242 that is stored in a third housing 246 with water that is 25% or less by weight of the second composition 226. The at least one third active ingredient 242 has a toxic or mitigating characteristic that tends to kill or mitigate undesirable organisms such as Karenia brevis when the at least one third active ingredient 242 is in contact with the targeted undesirable organism 247 as shown in a tenth enhanced view 248, more specifically Karenia brevis which forms a Red Tide bloom in a third body of water 250 that has a second surface 252. The third body of water 250 has a weight of water that is more than the third weight 228 of the second composition 226. The second composition 226, when stored in the third housing 246 with 25% or less by weight of water, forms a second disorganized phase 254. The second disorganized phase is defined by the majority of the at least one third active ingredient 242 not being surrounded by at least one fourth emulsifier 234 and the at least one fifth emulsifier 238 in formed droplets.

The second composition 226 can be dispensed or introduced into the third body of water 250 by a variety of methods. The self-encapsulating concentrate may be dispersed in a variety of ways, including by hand or using dispensing machinery to “spray” the second composition 226 directly to the second surface 252 of the third body of water 250 that includes the bloom that is formed by the Karenia brevis 247.

Upon entering the third body of water 250, defined self-emulsifying ingredients of the second composition 226 surround the at least one third active ingredient 242 semi-spontaneously to form micro or nano droplets or a second spherical 256 and subsequently disperse and suspend within a water column 258 that is within the third body of water 250 which can be seen in an eleventh enhanced view 253. Once dispersed, the droplets become capable of inhibiting or killing the targeted microorganisms through direct contact. By utilizing the disclosed method, a locally high concentration of the at least one third active ingredient 242 in contact with the microorganisms 247 can be achieved. The droplets remain organized for at least 15 minutes, preferably at least 20 minutes, most preferably at least 30 minutes after being immersed in the third body of water 250. The relatively short period of time the droplets remain intact ensures treatments in wild environments or open water are only active for a short period of time which reduces any potential impact to nontargeted species or ecosystems. This is due to the at least one third active ingredient 242 possessing low solubility outside of their protective droplets or sphericals 256. As a result, upon breakdown of the droplet, the active ingredient particles dissolve to concentrations below harm, or become solid particulate without the means to penetrate plasma membranes or mucosal barriers.

This again provides a way or method to dispense a self-encapsulating active ingredient into a high concentration of an undesirable organism such as Karenia brevis. This method or dispersal utilizes a relatively small concentrated amount of self-encapsulated active ingredients while producing a delivery method that is tailored to provide a significant of time to allow the active ingredient or ingredients to reach their destination. This in turn holds promise as a way to fight effects of Red Tide using a more cost effective and efficient methodology.

What is claimed

1. A method of delivering at least one active ingredient to a collection of aquatic organisms utilizing a self-micro-emulsifying or self-nano emulsifying system comprising:
Providing a volume of treatment stored in a housing;
Providing a collection of aquatic organisms immersed in a body of water and in contact with a plasma membrane or a mucosal layer that is positioned between the body of water and the collection of aquatic organisms;
Dispensing a first portion of the volume of treatment into the body of water;
Forming the first portion into a collection of sphericals when the first portion contacts the body of water;
Contacting the plasma membrane or the mucosal layer with a second portion of the first portion,
Wherein each of the collection of sphericals comprises at least a first emulsifier, a second emulsifier different than the first emulsifier, and at least one active ingredient that has at least one of a hydrophobic, a lipophilic, or an oleophilic characteristic;
Wherein, when each of the collection of sphericals is within the body of water, each of the collection of sphericals has a first surface formed in the shape of a sphere, and has a first diameter that is measured by laser diffraction, dynamic light scattering or microscopy using a volume distribution calculation, which defines a second average diameter by averaging the measurement of each of the first diameters together;
Wherein each of the collection of sphericals is self-micro-emulsifying or self-nano-emulsifying within the body of water;
Wherein each of the collection of sphericals is configured to contact or penetrate into the plasma membrane or the mucosal layer when in contact with the plasma membrane or the mucosal layer, and
Wherein the active ingredient delivers at least one of a toxic property, a therapeutic property, or a source of nutrition to the collection of aquatic organisms when the second portion contacts or penetrates the plasma membrane or the mucosal layer.

2. The method of claim 1, wherein the second average diameter measures between a first range of 5 nanometers and 150 microns, preferably a second range of between 5 nanometers to 100 microns, more preferably a third range of between nanometers to 50 microns.

3. The method of claim 1, wherein the volume of treatment is stored in the housing in a liquid state and has a first weight, wherein 25% or less of the first weight is water.

4. The method of claim 1, wherein the therapeutic property has at least one of the following: an antibacterial, a taste deterrent, an antifungal, an antiviral, an antiprotozoal, an antiparasitic, an antiseptic, an anesthetic, an astringent, or an anti-inflammatory characteristic.

5. The method of claim 1, wherein the source of nutrition is a digestible fat, or a digestible oil.

6. The method of claim 1, wherein the at least one active ingredient has a hydrophobic property or possesses a positive Octanol-Water Coefficient.

7. The method of claim 1, wherein the wherein the body of water is confined within an aquarium or an isolation tank.

8. The method of claim 1, wherein the housing is sealed such that the volume of treatment is not exposed to air during storage.

9. The method of claim 1, wherein a majority of the collection of sphericals continue to hold each of the respective first surfaces in the spherical shape for at least 30 seconds, preferably at least 1 minute, preferably at least 2 minutes, preferably at least 5 minutes, preferable at least 10 minutes, preferably at least 15 minutes, preferably at least 20 minutes, most preferably at least 30 minutes.

10. The method of claim 4, wherein the volume of treatment does not produce an anesthetic effect on the first organism.

11. The method of claim 2, wherein the method includes the further step of delivering the sphericals to the collection of aquatic organisms topically.

12. The method of claim 2, further comprising:
wherein the therapeutic property has at least one of the following: an antibacterial, a taste deterrent, an antifungal, an antiviral, an antiprotozoal, an antiparasitic, an antiseptic, an astringent, or an anti-inflammatory characteristic;
wherein the at least one active ingredient has a hydrophobic property or possesses a positive Octanol-Water Coefficient;
wherein the collection of aquatic organisms comprises a first organism that is classified within the Class Chondrichthyes, and
wherein the active ingredient is configured to provide the therapeutic property to the first organism.

13. The method of claim 10, further comprising:
wherein the method includes the further step of delivering the sphericals to the collection of aquatic organisms topically;
wherein the therapeutic property has at least one of the following: an antibacterial, a taste deterrent, an antifungal, an antiviral, an antiprotozoal, an antiparasitic, an antiseptic, an astringent, or an anti-inflammatory characteristic;
wherein the at least one active ingredient has a hydrophobic property or possesses a positive Octanol-Water Coefficient;
wherein the collection of aquatic organisms comprises a first organism that is classified within the Class Chondrichthyes, and
wherein the active ingredient is configured to provide the therapeutic property to the first organism.

14. The method of claim 2, further comprising:
wherein the therapeutic property has at least one of the following: an antibacterial, a taste deterrent, an antifungal, an antiviral, an antiprotozoal,
an antiparasitic, an antiseptic, an astringent, or an anti-inflammatory characteristic;
wherein the at least one active ingredient has a hydrophobic property or possesses a positive Octanol-Water Coefficient;
wherein the collection of aquatic organisms comprises a second organism that is classified within the Class Malacostraca, and wherein the active ingredient is configured to provide the therapeutic property to the second organism.

15. The method of claim 10, further comprising:
wherein the method includes the further step of delivering the sphericals to the collection of aquatic organisms topically;
wherein the therapeutic property has at least one of the following: an antibacterial, a taste deterrent, an antifungal, an antiviral, an antiprotozoal, an antiparasitic, an antiseptic, an astringent, or an anti-inflammatory characteristic;
wherein the at least one active ingredient has a hydrophobic property or possesses a positive Octanol-Water Coefficient;
wherein the collection of aquatic organisms comprises a second organism that is classified within the Class Malacostraca, and
wherein active ingredient is configured to provide the therapeutic property to the second organism.

16. The method of claim 1, wherein the collection of aquatic organisms comprises a third organism that is classified within the class Anthozoa, wherein the active ingredient is configured to provide the therapeutic property to the third organism.

17. The method of claim 2, further comprising:
wherein the therapeutic property has at least one of the following: an antibacterial, a taste deterrent, an antifungal, an antiviral, an antiprotozoal, an antiparasitic, an antiseptic, an astringent, or an anti-inflammatory characteristic;
wherein the source of nutrition is a digestible fat, or a digestible oil;
wherein the at least one active ingredient has a hydrophobic property or possesses a positive Octanol-Water Coefficient;
wherein the collection of aquatic organisms comprises a third organism that is classified within the Class Anthozoa, and
wherein the active ingredient is configured to provide the therapeutic property to the third organism.

18. The method of claim 2, further comprising:
wherein the therapeutic property has at least one of the following: an antibacterial, a taste deterrent, an antifungal, an antiviral, an antiprotozoal, an antiparasitic, an antiseptic, an astringent, or an anti-inflammatory characteristic;
wherein the source of nutrition is a digestible fat, or a digestible oil;
wherein the at least one active ingredient has a hydrophobic property or possesses a positive Octanol-Water Coefficient;
wherein the collection of aquatic organisms comprises a fourth, fifth, sixth, seventh, eighth or ninth organism that is classified within the following Classes; Amphibia, Bivalvia, Cephalopoda, Gastropoda, Marine Based Mammalia, Reptilia, and
wherein the active ingredient is configured to provide the therapeutic property to the fourth, fifth, sixth, seventh, eighth or ninth organism.

19. The method of claim 2, further comprising:
wherein the at least one active ingredient has a toxic characteristic on a target organism and has a hydrophobic property or possesses a positive Octanol-Water Coefficient;
wherein the target organism is a marine or freshwater cyanobacteria within the Class Cyanophyceae.

20. The method of claim 2, further comprising:
wherein the at least one active ingredient has a toxic characteristic on a target organism and has a hydrophobic property or possesses a positive Octanol-Water Coefficient;
wherein the target organism is a marine or freshwater dinoflagellate within the Class Dinophyceae.

21. A method of delivering at least one active ingredient to toxins produced by a collection of aquatic organisms utilizing a self-micro-emulsifying or self-nano emulsifying system comprising:
Providing a volume of treatment stored in a housing;
Providing a collection of aquatic organisms immersed in a body of water that produce an aquatic toxin that is released into the body of water;
Dispensing a first portion of the volume of treatment into the body of water;
Forming the first portion into a collection of sphericals when the first portion contacts the body of water;
Contacting the aquatic toxin with a second portion of the first portion,
Wherein each of the collection of sphericals comprises at least a first emulsifier, a second emulsifier different than the first emulsifier, and at least one active ingredient that has at least one of a hydrophobic, a lipophilic, or an oleophilic characteristic;
Wherein, when each of the collection of sphericals is within the body of water, each of the collection of sphericals has a first surface formed in the shape of a sphere, and has a first diameter that is measured by laser diffraction, dynamic light scattering or microscopy using a volume distribution calculation, which defines a second average diameter by averaging the measurement of each of the first diameters together;
Wherein each of the collection of sphericals is self-micro-emulsifying or self-nano-emulsifying within the body of water, and
Wherein the active ingredient is configured to at least partially chemically inhibit or sequester the aquatic toxin when in contact with the aquatic toxin.

22. The method of claim 21, further comprising:
Wherein the collection of aquatic organisms is Karenia brevis, and the aquatic toxin is a brevotoxin.

23. The method of claim 22, further comprising:
Wherein the active ingredient is benzalkonium chloride, castor oil, cedarwood oil, cinnamon, cinnamon oil, citric acid, citronella, citronella oil, cloves, clove oil, corn gluten meal, corn oil, cornmint, cottonseed oil, calcium hypochlorite, dried blood, eugenol, garlic, garlic oil, geraniol, geranium oil, lauryl sulfate, lemongrass oil, linseed oil, malic acid, peppermint, peppermint oil, 1-phenylethyl propionate, potassium sorbate, egg white solids, rosemary, rosemary oil, sesame, sesame oil, sodium chloride, sodium lauryl sulfate, soybean oil, spearmint, spearmint oil, thyme, thyme oil, turmeric, white pepper, or zinc.
